(19) United States
(12) Patent Application Publication
(10) Pub. No.: US 2025/0154076 A1
(43) Pub. Date: May 15, 2025

(54) LIQUID FERTILIZERS FORMED FROM CONCENTRATED ANIMAL WASTE SUPERNATANT

(71) Applicant: Matthew Ryan BORNSTEIN, Muttontown, NY (US)

(72) Inventor: Matthew Ryan BORNSTEIN, Muttontown, NY (US)

(21) Appl. No.: 18/506,688

(22) Filed: Nov. 10, 2023

(51) Int. Cl. C05F 3/00; C05G 5/20

(52) U.S. Cl. CPC C05F 3/00; C05G 5/20

(57) ABSTRACT

Liquid fertilizers are described herein. The liquid fertilizers of the present disclosure are formed via concentration of animal waste/litter supernatant likely resulting in liquid fertilizer having appropriate nitrogen concentrations to facilitate plant and crop growth.

### FIELD OF DISCLOSURE

The present disclosure is related to liquid fertilizers which promote healthy and rapid growth of plants and crops. These fertilizers are produced from natural materials and result in fertilizer having appropriate nutrient content to facility such growth.

### BACKGROUND

Nitrogen is an essential nutrient for plants as a major component of chlorophyll, amino acids, adenosine triphosphate (ATP), and nucleic acids. the building blocks of proteins. Plants absorb nitrogen as either ammonium (NH₄⁺) or nitrate (NO₃⁻), but it is difficult for producers of organic fruits, vegetables, and crops to find cost-effective and allowed fertilizers comprised of these inorganic, plant-available nitrogen sources.

A commonly used source of nitrogen for plants and crops, particularly on organic farms, is manure. However, fertilizer based on manure is typically quite dilute (i.e., less than 1% total nitrogen), and, importantly, contains a large fraction of organic nitrogen that is not immediately plant-available, and is not economical to haul far distances. Furthermore, fertilizers having increased amounts of these components can also prove detrimental plants. For example, in the past, people have used chicken manure as part of a fertilizer mixture, but generally have not used chicken manure alone as fertilizer because of its high nitrogen content. The use of chicken manure with high nitrogen levels results in the roots burning and eventual plant death.

Organic fertilizers have also been derived from manure that has been processed. This processing may involve filtering organic waste and acidifying it. However, these processes are typically expensive due to the high cost of acidification and evaporation and provide limited range of fertilizer.

Accordingly, there is a continuing need for a method of manufacturing a fertilizer, particularly fertilizers suitable for use in organic agriculture.

### SUMMARY

In accordance with the foregoing objectives and others, the present disclosure provides methods of producing liquid fertilizers from livestock manure simply and economically. The liquid fertilizers of the present disclosure typically promote healthier and faster growth of plants and crops likely due to the removal of detrimental nutrients from manure.

The method for producing a liquid fertilizer product may comprise:
a) mixing an animal waste with a litter material (e.g., livestock bedding such as poultry bedding) and an aqueous solution (e.g., water) to form an animal waste mixture;
b) heating the animal waste mixture (e.g., above the boiling point of the aqueous solution); and
c) separating the liquid from the heated animal waste mixture as the liquid fertilizer or animal waste product.

Liquid fertilizers are also provided. The liquid fertilizers are typically formed from
a) mixing an animal waste with a litter material (e.g., livestock bedding such as poultry bedding) and an aqueous solution (e.g., water) to form an animal waste mixture;
b) heating the animal waste mixture (e.g., above the boiling point of the aqueous solution); and
c) separating the liquid from the heated animal waste mixture as the liquid fertilizer or animal waste product.

Typically, the animal waste comprises more than 90% chicken manure by weight of the animal waste (e.g., more than 95% by weight, more than 99% by weight). In some embodiments, the animal waste consists or consists essentially of chicken manure. In various implementations, the weight ratio of the animal waste and the litter material to the aqueous solution is from 10:1 to 1:10 (e.g., from 5:1 to 1:5, from 3:1 to 1:3, from 1:1 to 1:10, from 1:1 to 1:5, from 1:1 to 1:3, from 2:3 to 1:10 from 2:3 to 1:5, from 2:3 to 1:3).

Generally, the animal waste mixture is concentrated which may aid in the removal of various detrimental material from the liquid. This concentration may occur via, for example, heating. For example, in some embodiments, the heating step occurs at a temperature above the boiling point of the aqueous solution. In various implementations, the heating step decreases the volume of liquid in the animal waste mixture (e.g., decrease the volume from 20%-99%). In various aspects, the heating step comprises heating the animal mixture at a temperature of greater than (or up to 500° C.) 100° C. (e.g., from 100° C.-150° C., from 100° C.-120° C., from 150° C.-200° C., 150° C.-250° C.). In some embodiments, the aqueous solution is water optionally comprising one or more additives (e.g., pH adjuster, micronutrient, chelator, combinations thereof). In some embodiments, the litter material comprises, consists, or consists essentially of wood shavings (e.g., pine shavings).

The animal waste may be mixed with the litter material over a time period of one or more (e.g., from one to four weeks) by defecation of one or more livestock (e.g., poultry such as chicken) onto the litter material during the time period. In some embodiments, the animal waste is mixed with the litter material and the aqueous solution simultaneously or sequentially. In some embodiments, the animal waste and litter material is not pre-processed (e.g., the litter and animal waste mixture is taken from the livestock bed for mixing with the aqueous solution without further processing).

The liquid fertilizer may be a low-nitrogen fertilizer.

A method of increasing the health and/or productivity of a plant or crop (or seed thereof) is also provided which may comprise applying the liquid fertilizer of the present disclosure or a diluted version thereof to the plant or crop. In some embodiments, the liquid fertilizer is applied at least once a week (e.g., at least twice a week, at least three times a week, at least daily, from at least once a week to daily) to the plant or crop (or seed thereof). In various implementations the applying step comprises spraying the liquid fertilizer onto the plant or crop and/or spraying the liquid fertilizer onto soil from which the plant or crop is growing. In some embodiments, method may further comprise diluting the liquid fertilizer (e.g., by mixing with water) prior to the applying of the diluted liquid fertilizer to the plant or crop. For example, the diluted liquid fertilizer may have a dilution ratio of 10:1 to 1:10 (e.g., from 5:1 to 1:5, from 3:1 to 1:3).

### BRIEF DESCRIPTION OF FIGURES

FIGS. 1A and 1B show the increases in cabbage growth rate due to application of the liquid fertilizer of the present disclosure.

### DETAILED DESCRIPTION

Detailed embodiments of the present disclosure are disclosed herein; however, it is to be understood that the disclosed embodiments are merely illustrative of the disclosure that may be embodied in various forms. In addition, each of the examples given in connection with the various embodiments of the disclosure is intended to be illustrative, and not restrictive.

All terms used herein are intended to have their ordinary meaning in the art unless otherwise provided. All concentrations are in terms of percentage by weight of the specified component relative to the entire weight of the topical composition, unless otherwise defined.

As used herein, “a” or “an” shall mean one or more. As used herein when used in conjunction with the word “comprising,” the words “a” or “an” mean one or more than one. As used herein “another” means at least a second or more.

As used herein, all ranges of numeric values include the endpoints and all possible values disclosed between the disclosed values. The exact values of all half-integral numeric values are also contemplated as specifically disclosed and as limits for all subsets of the disclosed range. For example, a range of from 0.1% to 3% specifically discloses a percentage of 0.1%, 1%, 1.5%, 2.0%, 2.5%, and 3%. Additionally, a range of 0.1 to 3% includes subsets of the original range including from 0.5% to 2.5%, from 1% to 3%, from 0.1% to 2.5%, etc. It will be understood that the sum of all weight % of individual components will not exceed 100%.

By “consist essentially” it is meant that the ingredients include only the listed components along with the normal impurities present in commercial materials and with any other additives present at levels which do not affect the operation of the embodiments disclosed herein, for instance at levels less than 5% by weight or less than 1% or even 0.5% by weight. When an animal waste consists of a single source of animal waste, such as chicken waste, the single source is the only animal waste in the product, aside from those animal waste contaminants that may be found from typical manufacturing and collection of such single source.

The present disclosure includes liquid fertilizers which may be produced in a facile manner. These liquid fertilizers, when applied to plants or crops (or soil), may promote their healthy and rapid growth. The liquid fertilizers are typically formed from
a) mixing an animal waste with a litter material (e.g., livestock bedding such as poultry bedding) and an aqueous solution (e.g., water) to form an animal waste mixture;
b) heating the animal waste mixture (e.g., above the boiling point of the aqueous solution); and
c) separating the liquid from the heated animal waste mixture as the liquid fertilizer or animal waste product.

The waste is typically an organic waste that may be derived from an organic source. For example, the liquid organic waste may be derived from natural sources including, but not limited to, plant and animal-biproducts dairy product waste, livestock manure (e.g., dairy manure, chicken manure, or swine manure), liquid manure, worm castings, peat, guano, compost, blood meal, bone meal, fish meal, decomposing crop residue, cheese whey, dairy product waste, dry chicken manure, mixed liquor from food and livestock processing facilities, wastewaters from a variety of food processing operations, and combinations thereof.

The animal waste may be supplied by an animal waste feedstock. The animal waste may be waste matter excreted from animals as solid manure and/or urine, such as but not limited to that from human (municipal sewage or sludge), cattle (beef, dairy, buffalo, veal), horses, sheep, swine, poultry (chicken, turkey, ostrich, pigeon, etc.), goat, mink, veterinarian, stockyard, stable, race track, rodeo grounds, fairgrounds, feedlot, sale barn, confined animal feeding operations, zoo, aquatic (fish, shrimp), elk (and other game), llama, alpaca, as well as other operations and sources of sewage or animal waste, and any mixtures thereof. Animal waste feedstock as used herein may include such matter along with other materials normally present in agricultural operations where such matter is produced, such as straw, bedding (which is typically shredded paper, wood chip), hair, feathers, insects, rodents, etc., whether the ratio of such matter to such other materials ranges from very low to very high. Animal waste feedstock may include matter in its raw form, any prepared form, and mixtures thereof with other materials such as other bio matter (yard waste, green waste), additives, process aids, bone meal, fish meal and the like, including where the matter is fresh, fully bioconverted by composting, digestion, etc., or is at any stage in between.

Generally, the waste is a product that has been dispersed over the litter bed for a period of time sufficient to result in a liquid fertilizer providing the crop/plant benefit described herein. For example, the waste/litter mixture may be prepared over the course of from one day to three months (e.g., from one day to twelve weeks, from one day to eight weeks, from one day to four weeks, from one week to three weeks) with a number of livestock suitable for the amount of bedding provided.

The livestock diet may also be controlled to adjust the animal waste output. For example, in the case of poultry such as chickens, the poultry may be fed the same feed during manure collection and mixture with the litter, wherein the feed comprises protein (e.g., from 1-40% protein by weight), fat (e.g., from 1-5% fat by weight), and fiber (e.g., from 1-10% fiber by weight) such as those described by U.S. Pat. Nos. 3,644,121, 3,904,776, 6,403,142, 8,632,833, and 11,304,429, each of which are hereby incorporated by reference in their entirety and particularly in relation to animal feed.

Manure from domestic fowl, or poultry birds, may be especially suitable for use in the present manufacturing methods as they tend to be kept on farms and the like, making for abundant and convenient sourcing. In particular embodiments, the poultry manure is selected from chickens (including Cornish hens), turkeys, ducks, geese, and guinea fowl.

In some embodiments, the animal waste used in the present manufacturing process comprises, consists essentially, or consists of chicken manure. Chicken farms and other poultry farms may raise poultry as floor-raised birds (e.g., turkeys, broilers, broiler breeder pullets) where manure is comprised of the animal manure or droppings as well as bedding, feathers and the like. Alternatively, poultry farms may raise poultry as caged egg layers that are elevated from the ground and where manure consists mainly of fecal droppings (manure and uric acid) that have dropped through the cage. In particular aspects, the chicken manure is selected from the group consisting of egg layer chickens, broiler chickens, and breeder chickens. In a more particular embodiment, the manure comprises egg layer manure.

Some compositions of chicken manure are shown in Table 1 (analysis in wt % or ppm). The moisture content of the chicken manure may vary from 45% to 70% moisture. In addition to macro and micronutrients, the manure may contain a diverse population of microorganisms which have a potential of being plant growth-promoting bacteria (PGPB) and pathogenic bacteria. In some embodiments, the microorganisms may be added to the animal waste mixture. In some embodiments, the manufacturing process may reduce or eliminate the pathogenic organisms and cultivate beneficial organisms, including PGPBs (e.g., by heating at an appropriate temperature).

TABLE 1

| | Exemplary | Exemplary |
|---|---|---|
| Nutrient | Range^{†}* | Range^{†}* |
| Ammonium Nitrogen | 0.1%-2% | 0.29%-1.59% |
| Nitrate Nitrogen | 0.1%-4% | 1.5%-2.5% |
| Nitrite Nitrogen | 0.1%-4% | 1.5%-2.5% |
| Total Kjeldahl | 0.1%-4% | 0.66%-2.96% |
| Nitrogen (TKN) | | |
| P₂O₅ | 0.1%-5% | 1.88%-3.66% |
| K | 0.1%-4% | 1.33%-2.93% |
| Sulfur | 0.1%-4% | 0.89%-3.01% |
| Calcium | 0.1%-2% | 0.13%-0.88% |
| Magnesium | 0.1%-2% | 0.22%-0.60% |
| Sodium | 0.1%-2% | 0.10%-0.88% |
| Copper | >1000 ppm | >20 ppm-309 ppm |
| Iron | >1000 ppm | 314 ppm-911 ppm |
| Manganese | >1000 ppm | 100 ppm-493 ppm |
| Zinc | >1000 ppm | 97 ppm-553 ppm |
| Moisture | 25%-75% | 31%-71% |
| Total Solids | 25%-75% | 29%-69% |
| pH | 5-9 | 5.5-8.3 |
| Total Carbon | 10%-40% | 15%-30% |
| Organic Matter | 10%-40% | 15%-30% |
| Ash | 10%-40% | 15%-25% |
| Chloride | 0.1%-1% | 0.19%-0.80% |

^{†}Each Nutrient range may be optionally present in the chicken manure used to form the liquid fertilizer.
*Percentages refer to weight percentages.

In one aspect, the liquid fertilizer of the present disclosure can have a moisture content of from 20% to 80% or higher, by weight. In various aspects, the moisture content can be adjusted to a level of at least 75%, by weight, for example, 75%, 77%, 79%, 81%, 83%, 85%, 87%, 89%, or higher. In other aspects, the moisture content can be adjusted to a level of at least 80%, by weight, for example, at least 80%, 82%, 84%, 86%, 88%, 90%, 92%, 94%, 96%, or higher; or to a level of from 80% to 85% by weight. The animal waste feedstock may have a moisture content between 25% and 70% by weight, preferably between 20% and 30% by weight and most preferably between 30% and 40% by weight. Animal waste feedstock of lower moisture content, for example, as low as 10% by weight or even 20% by weight can be processed in embodiments. The solids content in many embodiments is primarily organic solids and microorganisms, and when obtained from mammals, particularly fecal coliforms. The microorganisms may include bacteria, protozoa, fungi or algae.

In one aspect, the moisture content can be adjusted, if needed, at any subsequent step of the process, using water and/or a nutrient enriched liquid. In one aspect, use of a nutrient enriched liquid can minimize and/or eliminate dilution of one or more desirable nutrients that can be present in the animal waste. Exemplary nutrients can include those compounds beneficial for fertilizer or agricultural applications, such as, nitrogen, phosphorus, and potassium. In one aspect, a nutrient enriched liquid can be water derived from the treatment methods described herein, for example, water that has been in contact with animal waste. In another aspect, a nutrient enriched liquid can be separately prepared using animal waste or desirable chemical compounds. In one aspect, the nutrient enriched liquid is prepared from water contacted with animal waste and does not introduce non-organic components into the treatment process. The proportions of nutrient enriched liquid and water, for example, clean or municipal water, used in the treatment process can vary, depending upon the animal waste being treated and/or the desired properties of the resulting treated product, and one of skill in the art could readily determine an appropriate proportion of nutrient enriched liquid and water to be used. In various aspects, the proportion can range from 100% water to 100% nutrient enriched liquid, and the present invention is intended to include all combinations there between.

The pH of the liquid fertilizer can vary, depending upon the type of animal, storage and/or environmental conditions, other materials present in the waste, or other factors. In various aspects, the liquid fertilizer, for example, a poultry litter, can have a pH of from 7.8 to 8.8. In one aspect, the pH of an animal waste can be adjusted, for example, to a neutral and/or slightly acidic value. In one aspect, the pH of the liquid fertilizer containing animal waste can be measured to determine what, if any, adjustment is needed. One of skill in the art could readily determine the pH of the liquid fertilizer and determine the degree of adjustment to be made. While not wishing to be bound by theory, it is believed that such an adjustment can neutralize any basic compounds present in the animal waste and prevent the formation and/or release of ammonia from nitrogen compounds present in the waste. In various aspects, the pH can be adjusted to a value of from 3 to 7, for example, 3, 3.5, 4, 4.5, 5, 5.5, 6, 6.5, or 7; from 4 to 7, for example, 4, 4.5, 5, 5.5, 6, 6.5, or 7; from 4.5 to 7, for example, 4.5, 5, 5.5, 6, 6.5, or 7; from 5 to 7, for example, 5, 5.2, 5.4, 5.6, 5.8, 6, 6.2, 6.4, 6.6, 6.8, or 7; from 5.5 to 7, for example, 5.5, 5.6, 5.7, 5.8, 5.9, 6, 6.1, 6.2, 6.3, 6.4, 6.5, 6.6, 6.7, 6.8, 6.9, or 7; or from 6 to 7, for example, 6, 6.2, 6.2, 6.3, 6.4, 6.5, 6.6, 6.7, 6.8, 6.9, or 7. It should be understood that the pH can be less than 6 or greater than 7, and the inventive methods are not intended to be limited to any particular pH value. In another aspect, an animal waste having a pH less than 6 or greater than 7 can be treated as described herein. In yet another aspect, an animal waste having a pH of from 6 to 7 can be treated as described herein and can maintain all or substantially all the nitrogen and/or other nutrients present in the waste as delivered and minimize and/or prevent the loss of nitrogen from the formation and release of ammonia.

In another aspect, if the liquid fertilizer, as delivered, has a pH of from 6 to 7, a reduced or no adjustment may be needed. A pH adjustment, if needed, can be performed using any suitable pH adjusting agent. In one aspect, any acidic compound can be applied and/or contacted with all or a portion of the liquid fertilizer. In another aspect, an acid can be contacted with all or a portion of the liquid fertilizer. Exemplary acids that can be utilized to adjust the pH of an animal waste can comprise citric acid, acetic acid, phosphoric acid, carbonic acid, hydrochloric acid, nitric acid, sulfuric acid, or a combination thereof. In a specific aspect, citric acid can be used. In another aspect, an acid derived from natural sources can be used. In yet another aspect, an acid that can be classified as an organic product can be used. Any pH adjusting agent, such as, for example, an acid, can be contacted as a solid or a liquid. In one aspect, a solution, for example, an aqueous solution of citric acid can be contacted with the liquid fertilizer. In another aspect, a solid, for example, citric acid powder, can be contacted with the liquid fertilizer. In yet other aspects, the liquid fertilizer can first be contacted with a liquid, such as, for example, water, to dilute the animal waste and facilitate improved contact with an acid or solution thereof. In one aspect, an animal manure can be contacted, for example, sprayed, with an aqueous citric acid solution to lower the pH to a desirable value and to curtail volatilization of ammonia containing compounds. Any suitable form and/or concentration of a pH adjusting agent can be utilized, and one of skill in the art could readily determine an appropriate pH adjusting agent, concentration, and method of delivery for a particular liquid fertilizer. In one aspect, an aqueous 50 wt. % solution of citric acid can be contacted with the animal manure or diluted slurry thereof. The mixture of acid and animal manure can be mixed, for example, by stirring or agitation, for a period ranging from, for example, 5 minutes to 60 minutes.

In various implementations, the animal waste used to make the liquid fertilizer may be processed prior to conversion into a liquid fertilizer. For example, this pre-processing is to decrease the moisture content of the solid product as much as possible, while separating and treating the contained moisture for reuse as gray water (e.g., wash water or irrigation water). The animal may be pre-processed prior to addition of the aqueous solution and subsequent heating and supernatant separation.

The liquid fertilizer may have a microorganism ingredient component (such as that found in the manure) or added to the liquid fertilizer during the manufacture. The microorganism may comprise a species from the genus Azobacter such as Azobacter chroococcum, Bacillus such as Bacillus polyfermenticus, Saccharomyces, Streptomyces, Trichoderma, or combinations thereof. The microorganism in the final product may have from 1-500 CFU/g (e.g., 50 CFU/g-150 CFU/g) liquid fertilizer.

Multiple micronutrients and additives may be added and mixed into the feedstock and/or aqueous solutions at any time during the production process (or pre-process) such as before mechanical shock, after titration, before titration or during titration of waste product of the fertilizer. For example, micronutrient cations such as manganese, magnesium, copper, zinc and iron optionally may be added in chelated forms. In an embodiment, the chelated forms are prepared by a non-aqueous process such as that described in U.S. Pat. No. 6,670,494, which is hereby incorporated by reference in its entirety.

Representative micronutrients which may be added to the animal waste, and some representative forms are:
zinc (e.g., zinc oxide, zinc acetate, zinc bensoate, zinc chloride, zinc citrate, zinc nitrate, zinc salicylate, ziram); iron (e.g., ferric chloride, ferric citrate, ferric fructose, ferric glycerophosphate, ferric nitrate, ferric oxide (e.g., saccharated), ferrous chloride, ferrous citrate ferrous fumarate, ferrous gluconate, ferrous succinate); manganese (e.g., manganese acetate, manganese chloride, manganese nitrate, manganese phosphate; copper (e.g., cupric acetate, cupric butyrate, cupric chlorate, cupric chloride, cupric citrate, cupric gluconate, cupric glycinate, cupric nitrate, cupric salicylate, cuprous acetate, cuprous chloride); boron (e.g., calcium borate, potassium borohydride, borax, boron trioxide, potassium borotartrate, potassium tetraborate, sodium borate, sodium borohydride, sodium tetraborate); molybdenum (e.g., molybdic acid, calcium molybdate, potassium molybdate, sodium molybdate); and cobalt (e.g., cobaltic acetate, cobaltous acetate, cobaltous chloride, cobaltous oxalate, cobaltous potassium sulfate, cobaltous sulfate).

One or more chelators may also be added before, during (preferably as chelate complexes with minerals) or after micronutrient addition. In some embodiments, the chelator is an organic acid such as an acid having an organic carbon backbone molecule having one, two or more carboxyl acid groups including citrate, malonic acid and gluconic acid. In certain embodiments, the organic acid has at least two carboxylic acid groups that are separated by at least one carbon atom, and more preferably at least two carbon atoms. Desirably the organic acid has between 2 and 20 carbon atoms.

Typically, the animal waste is raw animal waste (e.g., raw poultry waste such as raw chicken manure). Chicken farms and other poultry farms may raise poultry as floor-raised birds (e.g., turkeys, broilers, broiler breeder pullets) where manure is comprised of the animal manure or droppings which may be dispersed on bedding, feathers. In embodiments, where the manure includes bedding or litter, the liquid fertilizer product may or may not be prepared by adding additional litter material sufficient to result in increased health and/or productivity of plants or crops as described herein. Alternatively, poultry farms may raise poultry as caged egg layers that are elevated from the ground and where manure may consist mainly of fecal droppings (manure and uric acid) that have dropped through the cage. In particular aspects, the chicken manure is selected from the group consisting of egg layer chickens, broiler chickens, and breeder chickens. In a more particular embodiment, the manure comprises egg layer manure.

The animal waste may include any material that contains animal manure, including litter, bedding or any other milieu in which animal manure is disposed. In one aspect, “animal waste” comprises avian or fowl manure, more particularly poultry manure (e.g., chicken, turkey, duck, goose, guinea fowl). In particular, animal waste may comprise chicken manure, for example, from broilers or layers. In other aspects, animal waste can refer to waste from other animals, such as, for example, hogs, cattle, sheep, goats, or other animals not specifically recited herein. In yet another aspect, animal waste can refer to a mixture of waste products from two or more types of animals, for instance, two or more types of poultry.

Litter material generally refers to litter or bedding which animals (e.g., domesticated animals) defecate on. Poultry litter, for example, may refer to the bed of material on which poultry are raised in poultry rearing facilities. The litter can comprise a filler/bedding material such as sawdust or wood shavings (e.g., pine shavings) and chips, poultry manure, spilled food, and feathers.

The animal waste may be in the form of a manure slurry when used in the processes described herein. Manure slurry typically refers to a mixture of manure and any liquid, e.g., urine and/or water. Thus, in one aspect, a manure slurry can be formed when animal manure and urine are contacted, or when manure is mixed with water from an external source. No specific moisture and/or solids content is intended to be implied by the term slurry.

The processes of the present disclosure generally involve the dissolution of manure from the litter material into the aqueous solution to result as part of the animal waste mixture and concentration of the liquid animal waste mixture. Without wishing to be bound by theory, it is thought that the processes of the present disclosure result in a decreased nitrogen content while maintain the ratio of other components in the material. For example, in some embodiments, the weight ratio of nitrogen (in any or all forms such as the ammonium nitrogen, nitrate nitrogen, nitrate nitrogen, TKN, or combinations thereof) to total carbon may be decreased in the liquid fertilizer as compared to the animal waste used to produce the animal waste. In some embodiments, the weight ratio of nitrogen (in any or all forms such as the ammonium nitrogen, nitrate nitrogen, nitrate nitrogen, TKN, or combinations thereof) to phoshorus (e.g., P₂O₅) may be decreased in the liquid fertilizer as compared to the animal waste used to produce the animal waste. In various implementations, the weight ratio of nitrogen (in any or all forms such as the ammonium nitrogen, nitrate nitrogen, nitrate nitrogen, TKN, or combinations thereof) to potassium may be decreased in the liquid fertilizer as compared to the animal waste used to produce the animal waste. the weight ratio of nitrogen (in any or all forms such as the ammonium nitrogen, nitrate nitrogen, nitrate nitrogen, TKN, or combinations thereof) to magnesium may be decreased in the liquid fertilizer as compared to the animal waste used to produce the animal waste. In some embodiments, the weight ratio of nitrogen (in any or all forms such as the ammonium nitrogen, nitrate nitrogen, nitrate nitrogen, TKN, or combinations thereof) to sodium may be decreased in the liquid fertilizer as compared to the animal waste used to produce the animal waste. In some embodiments, the weight ratio of nitrogen (in any or all forms such as the ammonium nitrogen, nitrate nitrogen, nitrate nitrogen, TKN, or combinations thereof) to copper may be decreased in the liquid fertilizer as compared to the animal waste used to produce the animal waste. In some embodiments, the weight ratio of nitrogen (in any or all forms such as the ammonium nitrogen, nitrate nitrogen, nitrate nitrogen, TKN, or combinations thereof) to iron may be decreased in the liquid fertilizer as compared to the animal waste used to produce the animal waste. In some embodiments, the weight ratio of nitrogen (in any or all forms such as the ammonium nitrogen, nitrate nitrogen, nitrate nitrogen, TKN, or combinations thereof) to manganese may be decreased in the liquid fertilizer as compared to the animal waste used to produce the animal waste. In some embodiments, the weight ratio of nitrogen (in any or all forms such as the ammonium nitrogen, nitrate nitrogen, nitrate nitrogen, TKN, or combinations thereof) to zinc may be decreased in the liquid fertilizer as compared to the animal waste used to produce the animal waste.

The heating step typically occurs at a temperature above the boiling point of the aqueous solution. For example, water is used, the temperature may be above 100° C. In some embodiments, the aqueous solution optionally comprises one or more additives and the heating occurs at a temperature of from 100° C.-500° C. (e.g., 100° C.-150° C., 150° C.-200° C., 200° C.-250° C., 250° C.-300° C., 300° C.-350° C., 350° C.-400° C., 400° C.-450° C., 450° C.-500° C., 100° C.-250° C.). In various implementations the heating occurs at a temperature and at a boiling point for a time sufficient to concentrate and decrease the liquid volume present. For example, the liquid volume of the liquid supernatant used to form the liquid fertilizer after the heating process may be more than (or up to 99%) 30% of the liquid volume added (e.g., from 30%-80%, from 40%-80%).

In certain embodiments, the liquid component during the heating is maintained at the elevated temperature for a period of several hours to several days. A range of between 1 day and 18 days is often used. In certain embodiments, the conditions can be maintained for 1, 2, 3, 4, 5, 6, 7, 8 or more days. For purposes of guidance only, the bioreaction is maintained at the elevated temperature for a longer period, e.g., three or more days, to ensure suitable reduction of pathogenic organisms, for instance to meet guidelines for use on food portions of crops. However, inasmuch as the length of the bioreaction affects the biological and biochemical content of the bio-reacted product, other times may be selected, e.g., several hours to one day or two days.

The liquid compositions can be formulated in a variety of ways such as for application to dryland crop systems, field irrigation, drip irrigation, hydroponic and/or other soil-free systems, and turf, among others. They can also be formulated for hydroponic, aeroponic and foliar spray application. They are also formulated for use in various soil-less media, including organic media such as peat moss, composted pine bark, coir and the like, and inorganic media such as sand, vermiculite, perlite, rock wool and the like.

The liquid compositions may be used to advantage on any plant or crop, including but not limited to angiosperms, gymnosperms, ferns and mosses. These include, but are not limited to: cereals, such as wheat, barley, rye, oats, rice, maize and sorghum; legumes, such as beans, lentils, peas, soybeans, clover and alfalfa; oil plants, such as canola, mustard, poppy, olives, sunflowers, coconut, castor beans, cocoa beans and groundnuts; beet including sugar beet and fodder beet; cucurbits, such as zucchini, cucumbers, melons, pumpkins, squash and gourds; fiber plants, such as cotton, flax, hemp and jute; fruit, such as stone fruit and soft fruit, such as apples, pears, plums, peaches, almonds, cherries, grapes (for direct consumption or for wine production) and berries, e.g. strawberries, raspberries and blackberries; citrus fruit, such as oranges, lemons, grapefruit and mandarins; vegetables, such as spinach, lettuce, asparagus, cabbages, carrots, onions, tomatoes, potatoes and paprika; trees for lumber or forestation, such as oak, maple, pine and cedar; and also tobacco, nuts, coffee, eggplant, sugar cane, tea, pepper, hops, bananas, natural rubber plants, Cannabis, turfgrasses and ornamentals (e.g., woody perennial, foliage and flower ornamentals, and ornamental grasses). The liquid fertilizer compositions of the present disclosure may be low-nitrogen fertilizers. Plants that may see the most pronounced benefit are those which have adverse reactions to high nitrogen fertilizers. In various implementations, the plant or crop is a perennial herb (e.g., rosemary, thyme, sage) root crop (e.g., carrot, beet, radish), potatoes, cucumbers, squash, pumpkins, peas, or cabbage.

The compositions also will find utility in non-plant crops, for instance in mushroom culture, wherein they may be advantageously applied to substrates such as straw (e.g., cereal straw), enriched sawdust, compost, paper and paper products (e.g., shredded cardboard), plant debris and other organic materials such as seed shells, corncobs, and banana fronds. The compositions can also be formulated for use in culture of algae, including cyanobacteria, which are produced commercially for a variety of purposes. For instance, algae are often cultivated for use as nutritional supplements. Additionally, they are used in photobioreactor systems to recycle flue gas emissions (e.g., carbon dioxide) from operations such as power generating plants.

It is noteworthy that the liquid compositions are aqueous and easy to mix with other aqueous materials and to formulate for drip or spray applications. They have been noted in particular for their ease of use for applications involving spraying or liquid application to crops.

The effect of the composition on the health or productivity of the plant can be observed or measured by any means know in the art. For example, plant health or productivity can be observed or measured by one or more of: germination rate, germination percentage, robustness of germination (e.g., hypocotyl, epicotyl, radicle or cotyledon development), root biomass, root structure and development, total biomass, stem, leaf or flower size, crop yield, structural strength/integrity, photosynthetic capacity, time to crop maturity, yield quality (e.g., dry matter, starch and sugar content, protein content, appearance, Brix value), resistance or tolerance to stress (e.g., heat, cold, drought, hypoxia, salinity); and resistance or tolerance to pests or pathogens, (e.g., insects, nematodes, weeds, fungi, bacteria and/or viruses). In certain embodiments, plants treated with the compositions of the invention are compared with untreated plants. “Untreated” plants can include plants treated with a “control,” such as water, or plants treated with one or more other compositions, or plants not treated with any compositions. In other embodiments, various parameters of treated plants can be compared with historical measurements for that type of plant in other locations or at other times (e.g., past seasons). Thus, in various embodiments, one or more parameters of growth and/or productivity can be measured between or among the same or an equivalent crop: (a) grown in substantially the same location during the same growing season; or (b) grown in the substantially same location during a different growing season; or (c) grown in a different location during the same growing season; or d) grown in a different location during a different growing season. “The same or equivalent crop” is intended to mean the same plant genus or the same plant species or the same plant subspecies or variety. “Substantially the same location” is intended to mean, for instance, in an adjacent or nearby plot, or in an adjacent or nearby field, or within a defined geographical distance, e.g., closer than one mile apart. For purposes of such comparison, observations, or measurements of parameters of plant health and/or productivity can be made by any convenient or available method, or any combination of methods. These can include, but are not limited to, visual observations, field measurements and labor.

### EXAMPLES

The following examples illustrate specific aspects of the instant description. The examples should not be construed as limiting, as the example merely provides specific understanding and practice of the embodiments and its various aspects.

### Example 1: Evaluation of Growth Promotion of Liquid Fertilizer in Cabbage

The excrement from 10 chickens was collected on litter material having dimensions 12″× 8″× 3″ over two weeks. The chickens were feed Purina Flock Raiser® Pellets (20% protein, 3.5% fat, 5% fiber). The litter material was pine shavings.

A mixture of 2 lbs (907 g) of pine shavings and chicken manure in a tin filled with 5 cups (1183 g) of tap water. The mixture was heated at 400° C. with slight agitation. After 30 minutes, the remaining fluid was observed to have a darkish brown translucent color. The fluid was drained to use as a liquid fertilizer for subsequent evaluation. 2-3 cups (470 g-710 g) of liquid fertilizer was recovered.

Liquid fertilizer was applied to soil comprising cabbage (Brassica oleracea) sprouts and compared to control. Both test and control groups were measured on a cabbage sprout planted in a cup with a 2.75″ OD and 2″ height. The control group was not provided any fertilizer while the soil in the test group was applied the liquid fertilizer. Both groups received equal amounts of light and water.

The growth of each cabbage sprout measured daily for each group for 7 days. Table 2 provides the measured cabbage growth for each day.

TABLE 2

| Day | No Fertilizer (cm) | Liquid Fertilizer (cm) |
|---|---|---|
| 1 | 1.8 | 2.3 |
| 2 | 2.6 | 3.1 |
| 3 | 2.9 | 3.6 |
| 4 | 3.5 | 4.8 |
| 5 | 4.4 | 5.4 |
| 6 | 4.7 | 6.0 |
| 7 | 5.2 | 6.6 |

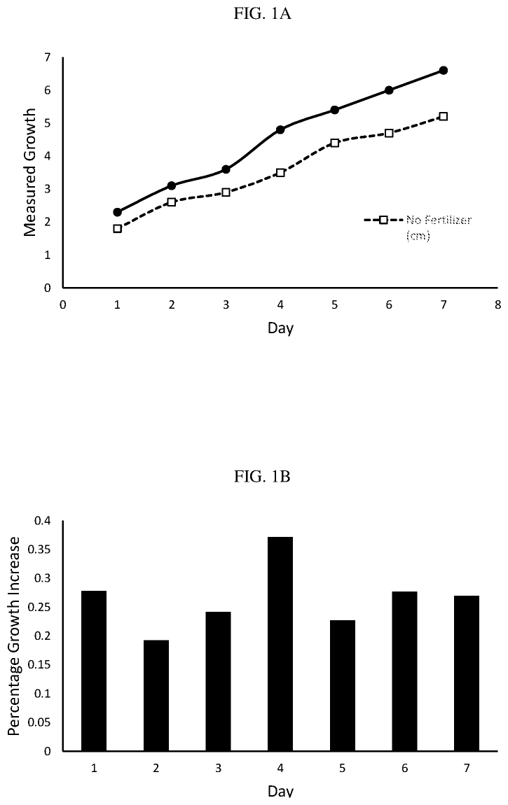

These results are shown in FIG. 1A. As can be seen, application of the liquid fertilizer of the present disclosure results in increases in growth of the cabbage sprouts consistently for each measurement as compared to control. This is further demonstrated in FIG. 1B, which details the percentage increase associated with liquid fertilizer application. All measurements resulted in growth increases of from 19% (day 2) to 37% (day 4). These results demonstrate that sprouts given a liquid fertilizer of the present disclosure grew at a faster rate than the cabbage sprouts without the liquid fertilizer.

### Example 2: Evaluation of Growth Promotion of Liquid Fertilizer in Pea Seeds

A similar evaluation to that described in Example 1 was performed on pea seeds (Lathyrus odoratus). Over the course of heating the liquid fertilizer, it was observed that the clear liquid water turned a similar translucent brown and darker color.

Liquid fertilizer application was compared to two different controls: 1) a control pea seed sprout having no fertilizer and 2) a control pea seed sprout having been applied chicken manure directly and without processing as described herein. As in Example 1, the liquid fertilizer of the present disclosure was observed to consistently result in increased growth of the pea seed as compared to no fertilizer control. Furthermore, the pea seeds that grew in the liquid control group looked greener and healthier than the no fertilizer control. With regard to the raw manure control, the pea seeds did not sprout likely due to the high nitrogen content of the manure. Without wishing to be bound by theory, it is believed the liquid fertilizers of the present disclosure promote healthy and faster growth of plants and crops due to attenuation of the proper nitrogen content. By condensing the litter/manure mixture directly, the resultant supernatant maintains the nutrients responsible for healthy growth while decreasing those which may be detrimental such as nitrogen including organic nitrogen.

As various changes can be made in the above-described subject matter without departing from the scope and spirit of the present disclosure, it is intended that all subject matter contained in the above description, or defined in the appended claims, be interpreted as descriptive and illustrative of the present disclosure. Many modifications and variations of the present disclosure are possible in light of the above teachings. Accordingly, the present description is intended to embrace all such alternatives, modifications and variances which fall within the scope of the appended claims.

All documents cited or referenced herein and all documents cited or referenced in the herein cited documents, together with any manufacturer's instructions, descriptions, product specifications, and product sheets for any products mentioned herein or in any document incorporated by reference herein, are hereby incorporated by reference, and may be employed in the practice of the disclosure.

1. A method for producing a liquid fertilizer product comprising:
a) mixing an animal waste with a litter material (e.g., livestock bedding such as poultry bedding) and an aqueous solution (e.g., water) to form an animal waste mixture;
b) heating the animal waste mixture (e.g., above the boiling point of the aqueous solution); and
c) separating the liquid from the heated animal waste mixture as the liquid fertilizer or animal waste product.

2. The method according to claim 1, when the animal waste comprises more than 90% chicken manure by weight of the animal waste.

3. The method according to claim 1, wherein the animal waste consists or consists essentially of chicken manure.

4. The method according to claim 1, wherein the weight ratio of the animal waste and the litter material to the aqueous solution is from 10:1 to 1:10.

5. The method according to claim 1, wherein the heating step occurs at a temperature above the boiling point of the aqueous solution.

6. The method according to claim 1, wherein the heating step decreases the volume of liquid in the animal waste mixture.

7. The method according to claim 1, wherein the heating step comprises heating the animal mixture at a temperature of greater than.

8. The method according to claim 1, wherein the aqueous solution is water optionally comprising one or more additives.

9. The method according to claim 1, wherein the litter material comprises, consists, or consists essentially of wood shavings.

10. The method according to claim 9, wherein the wood shavings are pine shavings.

11. The method according to claim 1, wherein the animal waste is mixed with the litter material over a time period of one or more by defecation of one or more livestock onto the litter material during the time period.

12. The method according to claim 11, wherein the liquid fertilizer is a low-nitrogen fertilizer.

13. The method according to claim 1, wherein the animal waste and litter material is not pre-processed (e.g., the litter and animal waste mixture is taken from the livestock bed for mixing with the aqueous solution without further processing).

14. A liquid fertilizer formed from the method according to claim 1.

15. A method of increasing the health and/or productivity of a plant or crop (or seed thereof) comprising applying the liquid fertilizer according to claim 14 or a diluted version thereof to the plant or crop.

16. The method according to claim 15, wherein the liquid fertilizer is applied at least once a week to the plant or crop (or seed thereof).

17. The method according to claim 15, wherein the applying step comprises spraying the liquid fertilizer onto the plant or crop and/or spraying the liquid fertilizer onto soil from which the plant or crop is growing.

18. The method according to claim 15, further comprising diluting the liquid fertilizer (e.g., by mixing with water) prior to the applying of the diluted liquid fertilizer to the plant or crop.

19. The method according to claim 18, wherein the diluted liquid fertilizer had a dilution ratio of 10:1 to 1:10.
